(19) United States
(12) Patent Application Publication
(10) Pub. No.: US 2017/0279766 A1
(43) Pub. Date: Sep. 28, 2017

(54) GROUP ADDRESSES IN WIRELESS NETWORKS

(71) Applicants: Chittabrata Ghosh, Fremont, CA (US); Yaron Alpert, Hod Hasharoni (IL)

(72) Inventors: Chittabrata Ghosh, Fremont, CA (US); Yaron Alpert, Hod Hasharoni (IL)

(21) Appl. No.: 15/079,061

(22) Filed: Mar. 24, 2016

(51) Int. Cl. H04L 29/12; H04W 72/04

(52) U.S. Cl. CPC H04L 61/2069; H04W 72/04; H04W 84/12

(57) ABSTRACT

Apparatuses, methods, and computer readable media are disclosed for group addresses in wireless networks. An apparatus of an access point comprising memory and processing circuitry coupled to the memory is disclosed. The processing circuitry may be configured to: allocate one or more association identification (AIDs) to one or more stations, and allocate a group association identification (GAI) for the one or more stations and associate the GAI with the one or more AIDs. The processing circuitry may be further configured to: encode one or more first packets with the GAI for the one or more stations, and configure the access point to transmit the one or more first packets to the one or more stations. The processing circuitry may be further configured to: encode a second packet with a media access control (MAC) address of the GAI, and transmit the second packet to the one or more stations.

### TECHNICAL FIELD

Embodiments relate to wireless devices. Some embodiments relate to Institute of Electrical and Electronic Engineers (IEEE) 802.11. Some embodiments relate to high-efficiency (HE) wireless local-area networks (WLANs). Some embodiments relate to IEEE 802.11ax. Some embodiments relate to apparatuses, computer readable media, and methods of group addresses in wireless networks. Some embodiments relate to compressing group addresses in wireless networks.

### BACKGROUND

Efficient use of the resources of a wireless network is important to provide bandwidth and acceptable response times to the users of the wireless network. Moreover, wireless devices may need to operate with both newer protocols and with legacy device protocols. Some wireless devices may operate with limited power and may have limited functionality. Moreover, there may be many limited power and/or limited functionality wireless devices.

Thus, there are general needs for methods, apparatuses, and computer readable media for location based query for low power devices.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments.

FIG. 2 illustrates a method for group addresses in a wireless network in accordance with some embodiments;

FIG. 3 illustrates a method for group addresses in a wireless network in accordance with some embodiments;

FIG. 4 illustrates a method of compressing a group address identifier (GAI) to a compressed GAI (C-GAI) in accordance with some embodiments;

FIG. 5 illustrates a GAI or C-GAI as a MAC address in a MAC frame 500 in accordance with some embodiments;

FIG. 6 illustrates a GAI or C-GAI as a group address in a resource allocation element and a resource allocation information element in accordance with some embodiments;

FIG. 7 illustrates group addresses in a wireless network in accordance with some embodiments; and

FIG. 8 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

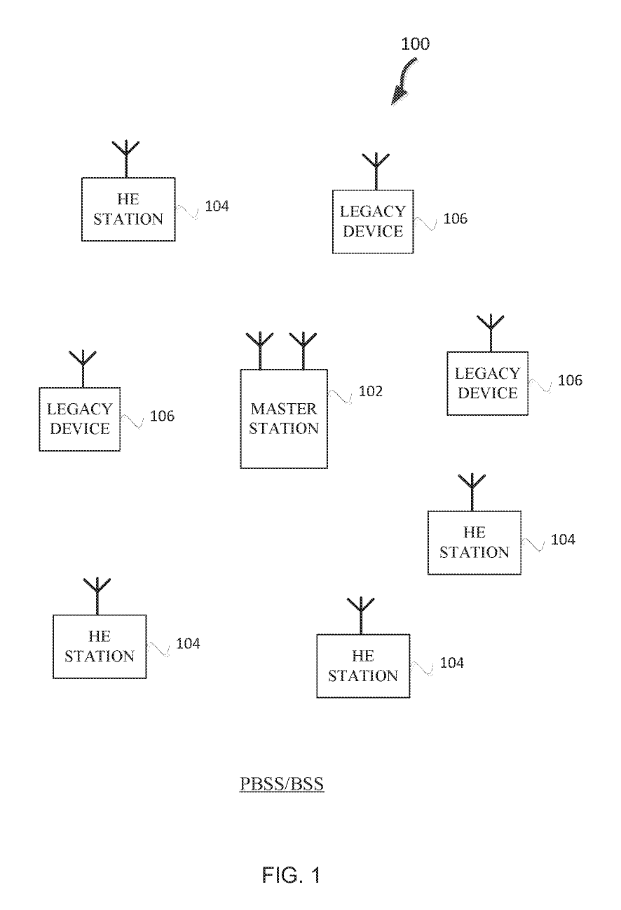

FIG. 1 illustrates a WLAN 100 in accordance with some embodiments. The WLAN may comprise a basis service set (BSS) 100 that may include a master station 102, which may be an AP, a plurality of high-efficiency wireless (e.g., IEEE 802.11ax) (HE) stations 104, and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one master station 102 that is part of a extended service set (ESS). A controller may store information that is common to the more than one master stations 102.

The legacy devices 106 may operate in accordance with one or more of IEEE 802.11 a/b/g/n/ac/ad/af/ah/aj/ay or another legacy wireless communication standard. The legacy devices 106 may be STAs or IEEE STAs. The HE STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 104 may be termed high efficiency (HE) stations.

The master station 102 may communicate with legacy devices 106 in accordance with legacy IEEE 802.11 communication techniques. In example embodiments, the master station 102 may also be configured to communicate with HE STAs 104 in accordance with legacy IEEE 802.11 communication techniques.

In some embodiments, a HE frame may be configurable to have the same bandwidth as a subchannel. The bandwidth of a subchannel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a subchannel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the subchannels may be based on a number of active subcarriers. In some embodiments the bandwidth of the subchannels are multiples of 26 (e.g., 26, 52, 104, etc.) active subcarriers or tones that are spaced by 20 MHz. In some embodiments the bandwidth of the subchannels is 256 tones spaced by 20 MHz. In some embodiments the subchannels are multiple of 26 tones or a multiple of 20 MHz. In some embodiments a 20 MHz subchannel may comprise 256 tones for a 256 point Fast Fourier Transform (FFT).

A HE frame may be configured for transmitting a number of spatial streams, which may be in accordance with MU-MIMO. In other embodiments, the master station 102, HE STA 104, and/or legacy device 106 may also implement different technologies such as code division multiple access (CDMA) 2000, CDMA 2000 1X, CDMA 2000 Evolution-Data Optimized (EV-DO), interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11ax embodiments, a master station 102 may operate as a master station which may be arranged to contend for a wireless medium (e.g., during a contention period) to receive exclusive control of the medium for an HE control period. In some embodiments, the HE control period may be termed a transmission opportunity (TXOP). The master station 102 may transmit a HE master-sync transmission, which may be a trigger frame or HE control and schedule transmission, at the beginning of the HE control period. The master station 102 may transmit a tune duration of the TXOP and sub-channel information. During the HE control period, HE STAs 104 may communicate with the master station 102 in accordance with a non-contention based multiple access technique such as OFDMA or MU-AMMO. This is unlike conventional WLAN communications in which devices communicate in accordance with a contention-based communication technique, rather than a multiple access technique. During the HE control period, the master station 102 may communicate with HE stations 104 using one or more HE frames. During the HE control period, the HE STAs 104 may operate on a sub-channel smaller than the operating range of the master station 102. During the HE control period, legacy stations refrain from communicating.

In accordance with some embodiments, during the master-sync transmission the HE STAs 104 may contend for the wireless medium with the legacy devices 106 being excluded from contending for the wireless medium during the master-sync transmission. In some embodiments the trigger frame may indicate one or both of an uplink (UL) UL-MU-MIMO and/or UL OFDMA control period.

In some embodiments, the multiple-access technique used during the HE control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HE stations 104 in accordance with legacy IEEE 802.11 communication techniques. In some embodiments, the master station 102 may also be configurable to communicate with HE stations 104 outside the HE control period in accordance with legacy IEEE 802.11 communication techniques, although this is not a requirement.

in example embodiments, the HE device 104 and/or the master station 102 are configured to perform the methods and functions herein described in conjunction with FIGS. 1-7.

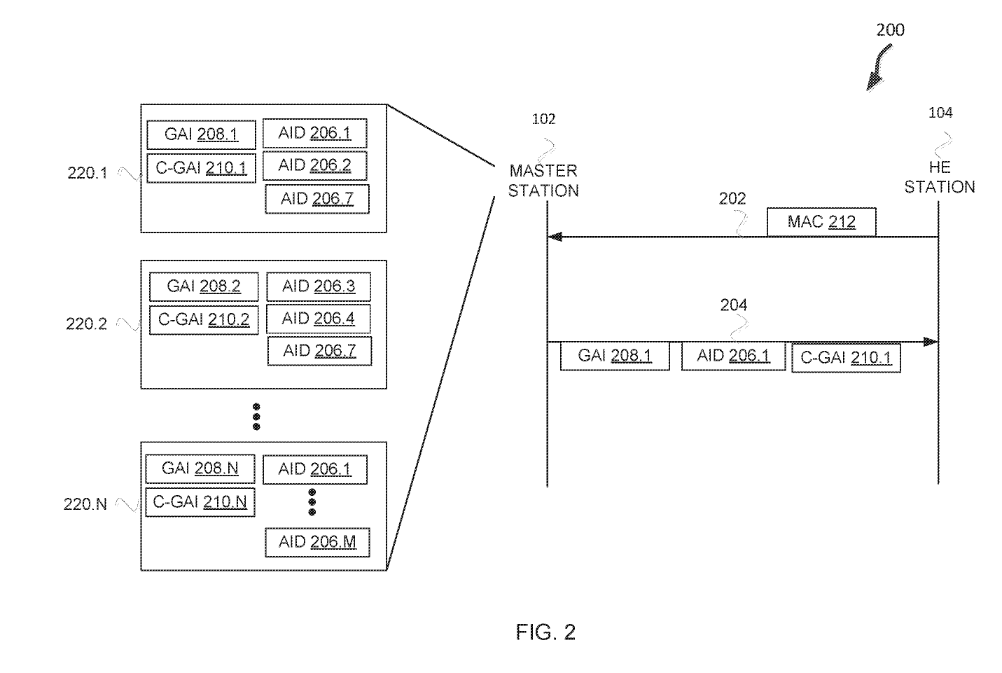

FIG. 2 illustrates a method 200 for group addresses in a wireless network in accordance with some embodiments. Illustrated in FIG. 2 is a master station 102 and HE station 104. The method 200 may be at operation 202 with the HE station 104 transmitting a request to associate with the master station 102. The request may include a media access control (MAC) 212 address of the HE station 104. The MAC 212 address may be 48 bits in accordance with some embodiments.

The method 200 may continue at operation 204 with the master station 102 transmitting a GAI 208.1, AID 206.1, and/or C-GAI 210.1 to the HE station 104. In some embodiments, the master station 102 may transmit the GAI 208.1, MD 206.1, and/or C-GAI 210.1 to the HE station 104 in a broadcast message, a traffic stream message, or another type of link condition change with the HE station 104.

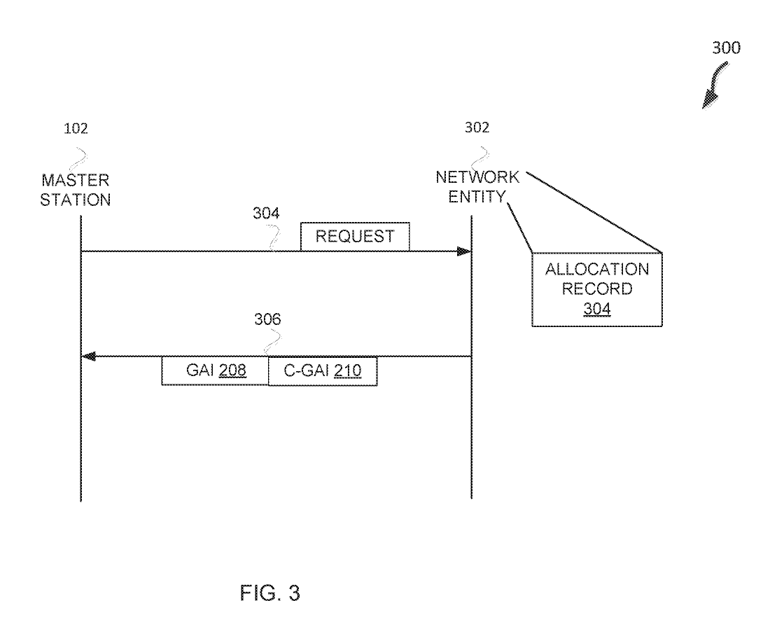

The master station 104 may comprise groups 220. The groups 220 may have a GAI 208, and, in some embodiments, a C-GAI 210. The groups 220 may have one or more HE stations 104 associated with the group 220. The HE stations 104 may be represented by association identifications (AIDs) 206 associated with the group 220. AIDs 206 may be generated by the master station 102 for the HE stations 104. The GAI 208 and/or C-GAIs 210 may be generated by the master station 102 in accordance with some embodiments. In some embodiments, a network entity 304 (FIG. 3) may send the master station 102 an indication of GAIs 208 and/or C-GAIs 120 to use as disclosed in conjunction with FIG. 3.

An example group 220.1 includes GAI 208.1, C-GAI 210.1, and AID 206.1, AID 206.2, and AID 206.7. The master station 102 may assign HE stations 104 to one or more groups 220.

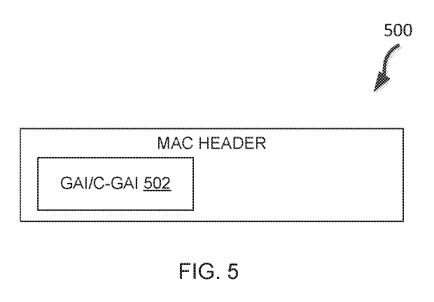

The GAIs 208 may be unique group address identifiers. The GAIs 208 may be unique for a local context of the BSS 100. The GAB 208 and/or C-GAIs 210 may be used as a MAC address in a multi cast transmission. The GAIs 208 and/or C-GAIs 210 may be used as the destination or receiver address in a MAC frame. In some embodiments the GAI 208 may be a 48 bit group address. In some embodiments, the GAI 208 may be compressed. In some embodiments, the GAI 208 may be a list of unique station identifiers. For example, the GAI 208 may be composed of one or more AIDs 206 or partial AIDs 206. In some embodiments the GAIs 208 and/or C-GAI 210 may begin with a 1 to indicate they are multicast MAC addresses. FIG. 5 illustrates a GAI or C-GAI 502 as a MAC address in a MAC frame 500 in accordance with some embodiments. The GAI/C-GAI 502 may identify the MAC frame 500 as a multicast frame for the group 220 of HE stations 104 with the GAI/C-GAI 502.

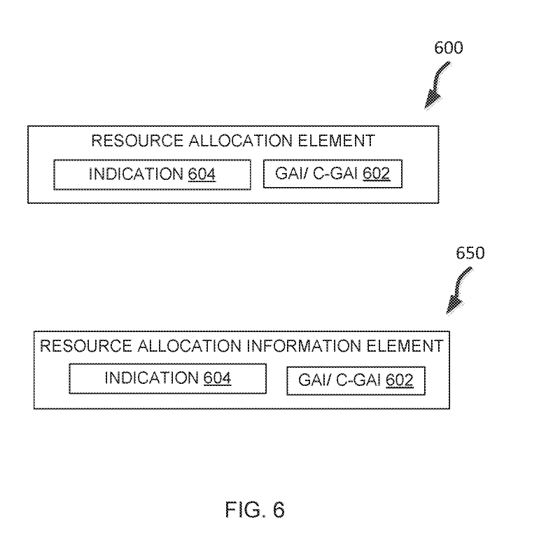

FIG. 6 illustrates a GAI or C-GAI 602 as a group address in a resource allocation element 600 and a resource allocation information element 650 in accordance with some embodiments. The GAI/C-GAI 602 may identify the group 220 of HE stations 104 with the GAI/C-GAI 602. The GAI/C-GAI 602 may in a field that may indicate individual addresses such as AIDs 206. In some embodiments, the resource allocation element 600 and/or resource allocation information element 650 may include an indication 604. The indication 604 may be a field that indicates that the GAI/C-GAI 602 is a group address. In some embodiments the indication 604 may be a field of another parameter where a range of values may indicate that the GAI/C-GAI 602 is a group address.

In some embodiments the GAI/C-GAI 602 is indicated in a station identification field. In some embodiments, a partial AID is used for a C-GAI. In some embodiments a range of AIDS is used for C-GAIs. For example, values of 500 to 600 of AIDs may be reserved for C-GAIs.

FIG. 3 illustrates a method 300 for group addresses in a wireless network in accordance with some embodiments. Illustrated in FIG. 3 is a master station 102 and network entity 302. The network entity 302 may be backend entity that the master station 102 communicates with via the Internet (not illustrated). The network entity 302 may be a central management entity for network elements such as the master station 102. In some embodiments, the network entity 302 is router or another master station 102. The method 300 begins at operation 304 with the master station 102 transmitting a request for GAIs 208 and/or C-GAI 210. In some embodiments, the master station 102 does not transmit the request. In some embodiments, the request indicates a number or range of GAIs 208 and/or C-GAIs 210 that the master station 102 is requesting. In some embodiments, the request may be part of a network discovery such as a probe request and probe response sequence. The method 300 continues at operation 306 with the network entity 302 transmitting one or more GAIs 208 and/or C-GAIs 210 to the master station 102. The network entity 302 may be configured to allocate GAI 208 and/or C-GAIs 210 to the master station 102 to insure they are locally unique. For example, there may be overlapping BSSs (OBSSs) with the BSS 100 of the master station 102. The network entity 302 may ensure that the GAI 208 and/or C-GAIs 210 do not overlap so that the GAIs 208 and/or C-GAIs 210 are unique locally. The network entity 302 may maintain an allocation record 304 of the master station 102 and GAIs 208 and/or C-GAIs 210 to insure the GAIs 208 and/or C-GAIs 210 are locally unique. In some embodiments, the network entity 302 may transmit the GAI 208 and/or C-GAI 210 to the master station 102 in a broadcast frame.

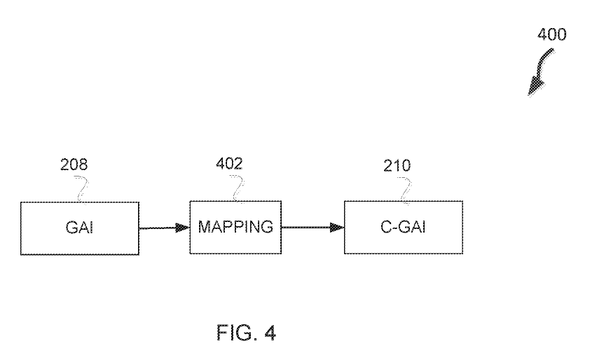

FIG. 4 illustrates a method 400 of compressing a group address identifier (GAI) to a compressed GAI (C-GAI) in accordance with some embodiments. Illustrated in FIG. 4 is GAI 208, mapping 402, and C-GAI 210. The mapping 402 may be a pre-defined look up compressing table from a 48 bit GAI 208 to a number of bits less than 48 bits. The length of the C-GAI 210 may be adjustable by the master station 102. In some embodiments the mapping 402 takes a portion of the GAI 208. For example, the C-GAI 210 may be a number of least significant bits of the GAI 208. In some embodiments, the mapping 402 may be performed by the network entity 302 (FIG. 3). In some embodiments the master station 102 generates C-GAI 210 and assigns them on a first come first served basis. In some embodiments the C-GAI 210 can allocate to one or more GAIs 208. The mapping 402 may be based on unicast identifications of the HE stations 104.

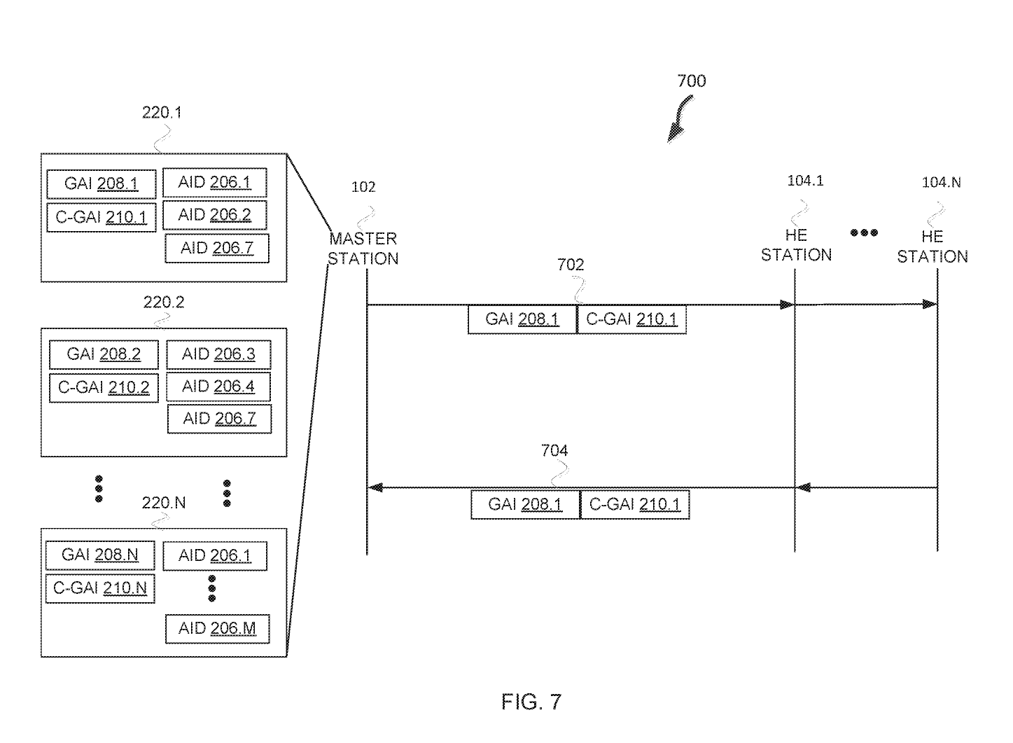

FIG. 7 illustrates group addresses in a wireless network in accordance with some embodiments. The master station 102 may transmit one or more packets 702 to the HE stations 104.1 through HE stations 104.n, HE stations 104.1 through HE stations 104.n may be members of a same group 220.1. The one or more packets 702 may include a GAI 208.1 or C-GAI 210.1 that indicates the HE station 104. In some embodiments, one of the packets 702 may include two or more GAIs 208.1 or C-GAI 210.1. One of the packets 702 may be a packet to initiate an event such as a report or information measurement such as a channel sounding. One of the packets 702 may allocate resources for the group 202.1. One of the packets 702 may restrict access for the group 202.1. In some embodiments, one of the packets 702 is a trigger frame for random access and the GAI 208.1 or C-GAI 210.1 may indicate either that the group 202.1 may transmit during the random access period or may not transmit during the random access period. For example, one of the packets 702 may be a trigger frame for random access and indicate two or more groups that may transmit during the random access period. In another example, one of the packets 702 may be a packet to set network allocation vector (NAV) setting for the group or groups indicated by one or more GAIs 208 or C-GAIs 210.

In some embodiments, the master station 102 may transmit the one or more packet 702 where some of the packets 702 include GAI 208.1 or C-GAI 210.1 and other packets have a MAC address of the AID 206 of the corresponding HE station 104.

One or more of the HE stations 104.1 through HE station 104.n may transmit packet 704 with a GAI 208.1 or C-GAI 210.1. Packet 704 may be unrelated to packet 702. Packet 704 may be an acknowledgment or block acknowledgment for one or more packets that may have been transmitted in packet 702. The GAI 208.1 or C-GAI 210.1 of packet 704 may act as an intensifier.

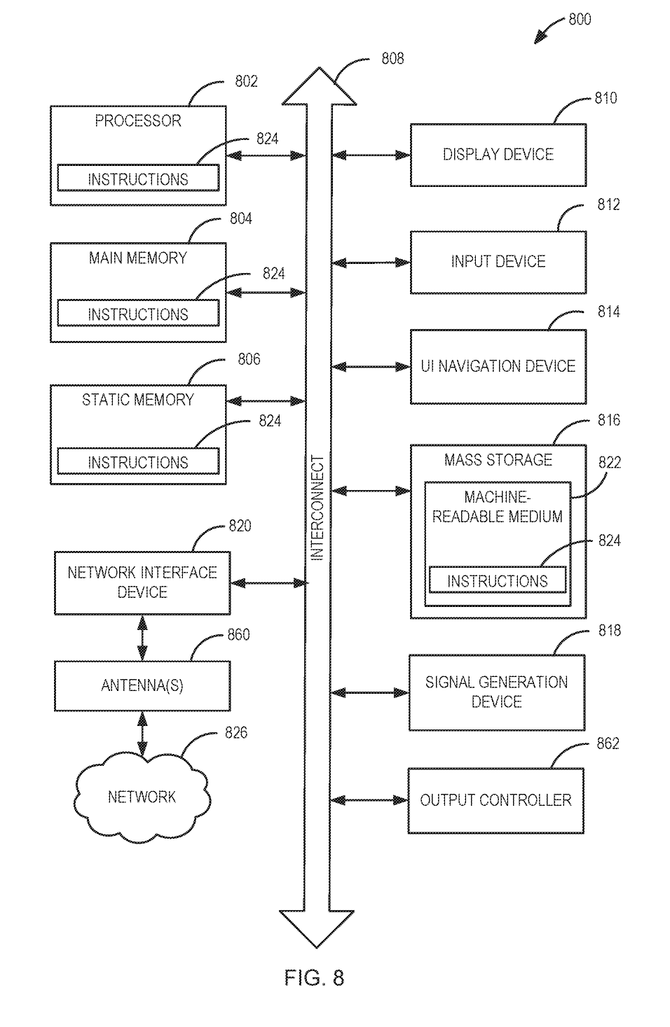

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 802 and/or instructions 824 may comprise processing circuitry.

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques. The term “transmission medium” shall be taken to include any intangible medium that is capable of storing, encoding or carrying instructions for execution by the machine 800, and includes digital or analog communications signals or other intangible medium to facilitate communication of such software.

The following examples pertain to further embodiments. Specifics in the examples may be used in one or more embodiments.

Example 1 is an apparatus of a wireless device including memory; and processing circuitry coupled to the memory, the processing circuitry configured to: allocate one or more association identification (AIDs) to one or more stations, allocate a group association identification (GAI) for the one or more stations and associate the GAI with the one or more AID, encode one or more first packets with the GAI for the one or more stations, configure the wireless device to transmit the one or more first packets to the one or more stations, encode a second packet with a media access control (MAC) address of the GAI, and configure the wireless device to transmit the second packet to the one or more stations.

In Example 2, the subject matter of Example 1 can optionally include where the processing circuitry is further configured to: encode a third packet including a resource allocation information element including the GAI, and configure the wireless device to transmit the third packet to the one or more stations, where the third packet comprises a MAC address with an indication of a broadcast address.

In Example 3, the subject matter of Example 2 can optionally include where the resource allocation information element comprises one of the following group: a field with an indication that an address field of the resource allocation information element comprises the GAI and a field where a range of values indicate that an address field of the resource allocation information element comprises the GAI.

In Example 4, the subject matter of any of Examples 1-3 can optionally include where the processing circuitry is further configured to: encode a third packet including a resource allocation element including the GAI, and configure the wireless device to transmit the third packet to the one or more stations, where the third packet comprises a MAC address with an indication of a broadcast address.

In Example 5, the subject matter of any of Examples 1-4 can optionally include where the processing circuitry is further configured to: receive the GAI from an entity, where the central management entity ensures the GAI is different from other GAI used by overlapping basic service sets.

In Example 6, the subject matter of any of Examples 1-5 can optionally include where the processing circuitry is further configured to: associate a compressed GAI (C-GAI) with the GAI.

In Example 7, the subject matter of Example 6 can optionally include where the processing circuitry is further configured to: generate the C-GAI from the GAI in accordance with one of the following group: assign a number of least significant bits of the GAI to the C-GAI, receive the C-GAI from an entity, map one of predefined C-GAIs to the GAI, and compress bits of the GAI.

In Example 8, the subject matter of Example 8 can optionally include where the processing circuitry is further configured to: encode a third packet including a resource allocation information element including the C-GAI; and configure the wireless device to transmit the third packet to the one or more stations, where the third packet comprises a MAC address with an indication of a broadcast address.

In Example 9, the subject matter of any of Examples 1-8 can optionally include where the processing circuitry is further configured to: encode one or more third packets with a MAC address of the corresponding one of the one or more AIDs of a selected station of the one or more stations, encode one or more fourth packets with either the GAI or a compressed GAI associated with the selected station, and configure the wireless device to transmit the one or more third packets and the one or more fourth packets intermixed to the selected station.

In Example 10, the subject matter of any of Examples 1-9 can optionally include where the GAI comprises the one or more AIDs or portions of the one or more AIDs.

In Example 11, the subject matter of any of Examples 1-10 can optionally include where the wireless device and the one or more stations are each at least one from the following group: a high-efficiency (HE) wireless local-area network (WLAN) station, a HE access point, a master station, an Institute of Electrical and Electronic Engineers (IEEE) 802.11ax access point, and an IEEE 802.11ax station.

In Example 12, the subject matter of any of Examples 1-11 can optionally include transceiver circuitry coupled to the memory.

In Example 13, the subject matter of Examples 12 can optionally include one or more antennas coupled to the transceiver circuitry.

Example 14 is a non-transitory computer-readable storage medium that stores instructions for execution by one or more processors. The instructions to configure the one or more processors to cause an wireless device to: allocate one or more association identification (AIDs) to one or more stations, allocate a group association identification (GAI) for the one or more stations and associate the GAI with the one or more AIDS, encode one or more first packets with the GAI for the one or more stations, configure the wireless device to transmit the one or more first packets to the one or more stations, encode a second packet with a media access control (MAC) address of the GAI, and transmit the second packet to the one or more stations.

In Example 15, the subject matter of Example 14 can optionally include where the instructions further configure the one or more processors to cause the wireless device to: encode a third packet including a resource allocation information element including the GAI, and configure the wireless device to transmit the third packet to the one or more stations, where the third packet comprises a MAC address with an indication of a broadcast address.

In Example 16, the subject matter of Examples 14 or 15 can optionally include where the resource allocation information element comprises one of the following group: a field with an indication that an address field of the resource allocation information element comprises the GAI and a field where a range of values indicate that an address field of the resource allocation information element comprises the GAI.

In Example 17, the subject matter of any of Examples 14-16 can optionally include where the instructions further configure the one or more processors to cause the wireless device to: encode a third packet including a resource allocation element including the GAI, and configure the wireless device to transmit the third packet to the one or more stations, where the third packet comprises a MAC address with an indication of a broadcast address.

Example 18 is an apparatus of a station including memory, and processing circuitry coupled to the memory, the processing circuitry configured to: decode one or more first packets including an association identification (AIDs) for an association with an access point and a group association identification (GAI), decode a second packet with a media access control (MAC) address of the GAI, and identify the second packet as addressed to the station based on the GAI.

In Example 19, the subject matter of Example 18 can optionally include where the processing circuitry is further configured to: decode a third packet including a resource allocation information element including the GAI, and determine the third packet is addressed to the station based on the GAI, where the third packet comprises a MAC address with an indication of a broadcast address.

In Example 20, the subject matter of Example 20 can optionally include where the resource allocation information element comprises one of the following group: a field with an indication that an address field of the resource allocation information element comprises the GAI and a field where a range of values indicate that an address field of the resource allocation information element comprises the GAI.

In Example 21, the subject matter of Examples 19 can optionally include where a first bit of the GAI is 1.

In Example 22, the subject matter of Examples 21 can optionally include transceiver circuitry coupled to the memory.

In Example 23, the subject matter of Example 18 can optionally include one or more antennas coupled to the transceiver circuitry.

Example 24 is a method performed by an access point, the method including: allocating one or more association identification (AIDS) to one or more stations, allocating a group association identification (GAI) for the one or more stations and associate the GAI with the one or more AIDs, encoding one or more first packets with the GAI for the one or more stations, configuring the access point to transmit the one or more first packets to the one or more stations, encoding a second packet with a media access control (MAC) address of the GAI, and transmitting the second packet to the one or more stations.

In Example 25, the subject matter of Example 24 can optionally include encoding a third packet including a resource allocation information element including the GAI, and configuring the access point to transmit the third packet to the one or more stations, where the third packet comprises a MAC address with an indication of a broadcast address.

Example 26 is an apparatus of a wireless device including: means for allocating one or more association identification (AIDS) to one or more stations, means for allocating a group association identification (GAI) for the one or more stations and associate the GAI with the one or more AIDs, means for encoding one or more first packets with the GAI for the one or more stations, means for configuring the wireless device to transmit the one or more first packets to the one or more stations, means for encoding a second packet with a media access control (MAC) address of the GAI, and means for configuring the wireless device to transmit the second packet to the one or more stations.

In Example 27, the subject matter of Example 27 can optionally include means for encoding a third packet including a resource allocation information element including the GAI, and means for configuring the wireless device to transmit the third packet to the one or more stations, where the third packet comprises a MAC address with an indication of a broadcast address.

In Example 28, the subject matter of Example 27 can optionally include where the resource allocation information element comprises one of the following group: a field with an indication that an address field of the resource allocation information element comprises the GAI and a field where a range of values indicate that an address field of the resource allocation information element comprises the GAI.

In Example 29, the subject matter of any of Examples 26-28 can optionally include means for encoding a third packet including a resource allocation element including the GAI, and means for configuring the wireless device to transmit the third packet to the one or more stations, where the third packet comprises a MAC address with an indication of a broadcast address.

In Example 30, the subject matter of any of Examples 26-29 can optionally include means for receiving the GAI from an entity, where the central management entity ensures the GAI is different from other GAI used by overlapping basic service sets.

In Example 31, the subject matter of any of Examples 26-30 can optionally include means for associating a compressed GAI (C-GAI) with the GAI.

in Example 32, the subject matter of Examples 31 can optionally include means for generating the C-GAI from the GAI in accordance with one of the following group: assign a number of least significant bits of the GAI to the C-GAI, receive the C-GAI from an entity, map one of predefined C-GAIs to the GAI, and compress bits of the GAI.

In Example 33, the subject matter of Example 32 can optionally include means for encoding a third packet including a resource allocation information element including the C-GAI, and means for configuring the wireless device to transmit the third packet to the one or more stations, where the third packet comprises a MAC address with an indication of a broadcast address.

In Example 34, the subject matter of any of Examples 26-33 can optionally include means for encoding one or more third packets with a MAC address of the corresponding one of the one or more AIDs of a selected station of the one or more stations, means for encoding one or more fourth packets with either the GAI or a compressed GAI associated with the selected station, and means for configuring the wireless device to transmit the one or more third packets and the one or more fourth packets intermixed to the selected station.

In Example 35, the subject matter of any of Examples 26-34 can optionally include where the GAI comprises the one or more AIDs or portions of the one or more AIDs.

In Example 36, the subject matter of any of Examples 26-35 can optionally include where the wireless device and the one or more stations are each at least one from the following group: a high-efficiency (HE) wireless local-area network (WLAN) station, a HE access point, a master station, an Institute of Electrical and Electronic Engineers (IEEE) 802.11ax access point, and an IEEE 802.11ax station.

In Example 37, the subject matter of any of Examples 26-36 can optionally include means for processing received radio signals and means for processing radio signals to be transmitted.

In Example 38, the subject matter of Example 37 can optionally include means for receiving and transmitting radio signals.

Example 39 is a non-transitory computer-readable storage medium that stores instructions for execution by one or more processors. The instructions to configure the one or more processors to cause an apparatus of a station to: decode one or more first packets including an association identification (AIDs) for an association with an access point and a group association identification (GAI), decode a second packet with a media access control (MAC) address of the GAI, and identify the second packet as addressed to the station based on the GAI.

In Example 40, the subject matter of Example 39 can optionally include where the instructions further configure the one or more processors to cause the station to: decode a third packet including a resource allocation information element including the GAI, and determine the third packet is addressed to the station based on the GAI, where the third packet comprises a MAC address with an indication of a broadcast address.

In Example 41, the subject matter of Examples 39 or 40 can optionally include where the resource allocation information element comprises one of the following group: a field with an indication that an address field of the resource allocation information element comprises the GAI and a field where a range of values indicate that an address field of the resource allocation information element comprises the GAI.

Example 42 is a method performed by an apparatus of a station, the method including: decoding one or more first packets including an association identification (AIDs) for an association with an access point and a group association identification (GAI), decoding a second packet with a media access control (MAC) address of the GAI, and identifying the second packet as addressed to the station based on the GAI.

In Example 43, the subject matter of Example 42 can optionally include decoding a third packet including a resource allocation information element including the GAI; and determining the third packet is addressed to the station based on the GAI, where the third packet comprises a MAC address with an indication of a broadcast address.

In Example 44, the subject matter of Examples 42 or 43 can optionally include where the resource allocation information element comprises one of the following group: a field with an indication that an address field of the resource allocation information element comprises the GAI and a field where a range of values indicate that an address field of the resource allocation information element comprises the GAI.

Example 45 is an apparatus of a station, the apparatus including: means for decoding one or more first packets including an association identification (AIDs) for an association with an access point and a group association identification (GAI), means for decoding a second packet with a media access control (MAC) address of the GAI, and means for identifying the second packet as addressed to the station based on the GAI.

In Example 46, the subject matter of Example 45 can optionally include decode a third packet including a resource allocation information element including the GAI, an determine the third packet is addressed to the station based on the GAI, where the third packet comprises a MAC address with an indication of a broadcast address.

In Example 47, the subject matter of Examples 46 or 47 can optionally include where the resource allocation information element comprises one of the following group: a field with an indication that an address field of the resource allocation information element comprises the GAI and a field where a range of values indicate that an address field of the resource allocation information element comprises the GAI.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless device comprising memory; and processing circuitry coupled to the memory, the processing circuitry configured to:
allocate one or more association identification (AIDs) to one or more stations;
allocate a group association identification (GAI) for the one or more stations and associate the GAI with the one or more AIDs;
encode one or more first packets with the GAI for the one or more stations;
configure the wireless device to transmit the one or more first packets to the one or more stations;
encode a second packet with a media access control (MAC) address of the GAI; and
configure the wireless device to transmit the second packet to the one or more stations.

2. The apparatus of claim 1, wherein the processing circuitry is further configured to:
encode a third packet comprising a resource allocation information element comprising the GAI; and
configure the wireless device to transmit the third packet to the one or more stations, wherein the third packet comprises a MAC address with an indication of a broadcast address.

3. The apparatus of claim 2, wherein the resource allocation information element comprises one of the following group: a field with an indication that an address field of the resource allocation information element comprises the GAI and a field where a range of values indicate that an address field of the resource allocation information element comprises the GAI.

4. The apparatus of claim 1, wherein the processing circuitry is further configured to:
encode a third packet comprising a resource allocation element comprising the GAI; and
configure the wireless device to transmit the third packet to the one or more stations, wherein the third packet comprises a MAC address with an indication of a broadcast address.

5. The apparatus of claim 1, wherein the processing circuitry is further configured to:
receive the GAI from an entity, wherein the central management entity ensures the GAI is different from other GAI used by overlapping basic service sets.

6. The apparatus of claim 1, wherein the processing circuitry is further configured to:
associate a compressed GAI (C-GAI) with the GAI.

7. The apparatus of claim 6, wherein the processing circuitry is further configured to:
generate the C-GAI from the GAI in accordance with one of the following group: assign a number of least significant bits of the GAI to the C-GAI, receive the C-GAI from an entity, map one of predefined C-GAIs to the GAI, and compress bits of the GAI.

8. The apparatus of claim 6, wherein the processing circuitry is further configured to:
encode a third packet comprising a resource allocation information element comprising the C-GAI; and
configure the wireless device to transmit the third packet to the one or more stations, wherein the third packet comprises a MAC address with an indication of a broadcast address.

9. The apparatus of claim 1, wherein the processing circuitry is further configured to:
encode one or more third packets with a MAC address of the corresponding one of the one or more AIDs of a selected station of the one or more stations;
encode one or more fourth packets with either the GAI or a compressed GAI associated with the selected station; and
configure the wireless device to transmit the one or more third packets and the one or more fourth packets intermixed to the selected station.

10. The apparatus of claim 1, wherein the GAI comprises the one or more AIDs or portions of the one or more AIDs.

11. The apparatus of claim 1, wherein the wireless device and the one or more stations are each at least one from the following group: a high-efficiency (HE) wireless local-area network (WLAN) station, a HE access point, a master station, an Institute of Electrical and Electronic Engineers (IEEE) 802.11ax access point, and an IEEE 802.11ax station.

12. The apparatus of claim 1, further comprising transceiver circuitry coupled to the memory.

13. The apparatus of claim 12, further comprising: one or more antennas coupled to the transceiver circuitry.

14. A non-transitory computer-readable storage medium that stores instructions for execution by one or more processors, the instructions to configure the one or more processors to cause a wireless device to:
allocate one or more association identification (AIDs) to one or more stations;
allocate a group association identification (GAI) for the one or more stations and associate the GAI with the one or more AIDs;
encode one or more first packets with the GAI for the one or more stations;
configure the wireless device to transmit the one or more first packets to the one or more stations;
encode a second packet with a media access control (MAC) address of the GAI; and
transmit the second packet to the one or more stations.

15. The non-transitory computer-readable storage medium of claim 14, wherein the instructions further configure the one or more processors to cause the wireless device to:
encode a third packet comprising a resource allocation information element comprising the GAI; and
configure the wireless device to transmit the third packet to the one or more stations, wherein the third packet comprises a MAC address with an indication of a broadcast address.

16. The non-transitory computer-readable storage medium of claim 15, wherein the resource allocation information element comprises one of the following group: a field with an indication that an address field of the resource allocation information element comprises the GAI and a field where a range of values indicate that an address field of the resource allocation information element comprises the GAI.

17. The non-transitory computer-readable storage medium of claim 14, wherein the instructions further configure the one or more processors to cause the wireless device to:
encode a third packet comprising a resource allocation element comprising the GAI; and
configure the wireless device to transmit the third packet to the one or more stations, wherein the third packet comprises a MAC address with an indication of a broadcast address.

18. An apparatus of a station comprising memory; and processing circuitry coupled to the memory, the processing circuitry configured to:
decode one or more first packets comprising an association identification (AIDS) for an association with an access point and a group association identification (GAI);
decode a second packet with a media access control (MAC) address of the GAI; and
identify the second packet as addressed to the station based on the GAI.

19. The apparatus of claim 18, wherein the processing circuitry is further configured to:
decode a third packet comprising a resource allocation information element comprising the GAI; and
determine the third packet is addressed to the station based on the GAI, wherein the third packet comprises a MAC address with an indication of a broadcast address.

20. The apparatus of claim 19, wherein the resource allocation information element comprises one of the following group: a field with an indication that an address field of the resource allocation information element comprises the GAI and a field where a range of values indicate that an address field of the resource allocation information element comprises the GAI.

21. The apparatus of claim 19, wherein a first bit of the GAI is 1.

22. The apparatus of claim 21, further comprising transceiver circuitry coupled to the memory.

23. The apparatus of claim 18, further comprising: one or more antennas coupled to the transceiver circuitry.

24. A method performed by an access point, the method comprising:
allocating one or more association identification (AIDs) to one or more stations;
allocating a group association identification (GAI) for the one or more stations and associate the GAI with the one or more AIDs;
encoding one or more first packets with the GAI for the one or more stations;
configuring the access point to transmit the one or more first packets to the one or more stations;
encoding a second packet with a media access control (MAC) address of the GAI; and
transmitting the second packet to the one or more stations.

25. The method of claim 24 further comprising:
encoding a third packet comprising a resource allocation information element comprising the GAI; and
configuring the access point to transmit the third packet to the one or more stations, wherein the third packet comprises a MAC address with an indication of a broadcast address.
